(19) United States
(12) Patent Application Publication
(10) Pub. No.: US 2008/0301146 A1
(43) Pub. Date: Dec. 4, 2008

(54) SYSTEM AND METHOD FOR EFFICIENT DYNAMIC AND CONNECTIVITY AWARE WEB PAGE RENDERING

(75) Inventor: Kamen VITANOV, Mississauga (CA)

Correspondence Address: MOFFAT & CO, 427 LAURIER AVEUE W., SUITE 1200, OTTAWA, ON, K1R 7Y2, CA

(73) Assignee: RESEARCH IN MOTION LIMITED, Waterloo (CA)

(21) Appl. No.: 11/756,171

(22) Filed: May 31, 2007

(51) Int. Cl. G06F 17/30

(52) U.S. Cl. 707/10; 707/E17.117

(57) ABSTRACT

A method and apparatus for dynamic and connectivity aware web page rendering on a device having at least one connection to an Internet protocol network, the method having the steps of: requesting a web page; receiving the web page requested along with links to at least one element within the web page; finding connectivity requirements for an element selected from the at least one element; checking whether attributes of any one of the at least one connection are better than the connectivity requirements for the element; and if yes, downloading the element using the any one of the at least one connection whose attributes are better than the connectivity requirements for the element.

### FIELD OF THE DISCLOSURE

The present disclosure relates to enhanced web browsing and in particular to the rendering of web pages on devices.

### BACKGROUND

Devices such as mobile devices are becoming increasingly sophisticated. In addition to providing voice communication capabilities, devices are increasingly being used for data communications. This includes electronic mail messages but also includes browsing networks such as the Internet.

A mobile device will generally communicate wirelessly through a radio frequency communications channel. Various standards for radio frequency communications are known to those in the art.

Other devices are known as dual mode or multi-mode wireless devices and can communicate through both wireless networks and other networks such as wireless fidelity (WiFi) networks, or through short range wired or wireless communications such as IrDA, Bluetooth™, USB, among others.

Other devices such as laptop computers also can communicate in one or more ways with Internet Protocol networks, and the use of the term mobile device in the present disclosure is meant to cover laptop computers as well as other similar devices.

With the advent of dual mode and multi-mode wireless devices, a device can have more than one connection to the Internet at a given time. This is referred to herein as the connectivity profile.

Mobile devices that allow browsing on the Internet have web browsers and currently these browsers render pages regardless of the current connectivity profile. In some cases the user can manually select which connection should be used for the duration of the browser session but there is no mechanism for intelligent and dynamic routing of incurred traffic over available connections.

### BRIEF DESCRIPTION OF THE DRAWINGS

The present application will be better understood with reference to the drawings in which:

FIG. 1 is a block diagram of an exemplary wireless data network in accordance with the present disclosure;

FIG. 2 is block diagram showing a method according to the present disclosure;

FIG. 3 is a block diagram showing an alternative method according to the present disclosure;

FIG. 4 is a block diagram of a device having modules for implementing the method of the present disclosure; and

FIG. 5 is a block diagram of an exemplary mobile device that can be used in accordance with the present method.

### DETAILED DESCRIPTION OF THE DRAWINGS

The connection profile of a mobile device has various characteristics. Examples include bandwidth, latency, cost, reliability and security. A wireless browser benefits from mechanisms for intelligent and dynamic routing of the incurred traffic over the available connections by taking into account the above characteristics.

A two part solution is presented herein. A first approach, referred to herein as a design time approach, allows every element within the web page to have connectivity requirements specified for it. The term “element” can be anything within a web page that is linked from the primary page. Examples of such links include images, sounds, videos, animations, among others.

In the design time approach, a designer of a web page can specify the properties of the connection that would allow the loading of that element. For example, a large image may require a bandwidth of at least 128 Kbs. Streaming animation may require that the latency be less than 1 second. A designer may realize that large packets cost the user money when browsing over a mobile wireless network and thus cost per traffic can be specified, wherein the element will only be loaded if the cost per traffic is less than a certain value. Reliability can be used for ensuring that, for example, receipts are acknowledged in certain cases, data integrity is maintained, and packet ordering is maintained. Security can be used for sites that are particularly security conscious. Some connections to mobile devices include non-secure links which a website may wish to avoid and thus certain security requirements may be required. These include data confidentiality, data integrity, data origin authentication, replay prevention, client authentication, server authentication and data non-repudiation, among others.

A second mode of operation is a run time mode. In this case, the mobile device originally receives the base web page with all of the elements as links within it. Such links are known to those skilled in the art and will be referred to herein as uniform resource locator (URL) links, although other links are possible. The mobile device browser can then decide whether or not to request the URL links based on the type of URL link. A modified mobile device is presented herein which includes both a decision module and a connection manager. These modules allow a decision to be made whether or not the element should be loaded.

The present specification therefore provides a method of dynamic and connectivity aware web page rendering on a device having at least one connection to an Internet protocol network, the method comprising the steps of: requesting a web page; receiving the web page requested along with links to at least one element within the web page; finding connectivity requirements for an element selected from the at least one element; checking whether attributes of any one of the at least one connection are better than the connectivity requirements for the element; and if yes, downloading the element using the any one of the at least one connection whose attributes are better than the connectivity requirements for the element.

The present specification further provides a device for dynamic and connectivity aware web page rendering, the device having a communications subsystem adapted to communicate utilizing at least one connection to an Internet protocol network; memory; a user interface; a processor adapted to run user applications and interact with the memory, the communications subsystem and the user interface and adapted to run applications, the device characterized by having: a fetching module utilizing the communications subsystem to request a web page and receive the web page requested along with links to at least one element within the web page; a connection module adapted to track attributes of the at least one connection; a decision module communicating with the fetching module and the communication module, the decision module adapted to find connectivity requirements for an element selected from the at least one element and check whether attributes of any one of the at least one connection are better than the connectivity requirements for the element; and if yes, the decision module being adapted to instruction the fetching module to download the element using the any one of the at least one connection whose attributes are better than the connectivity requirements for the element.

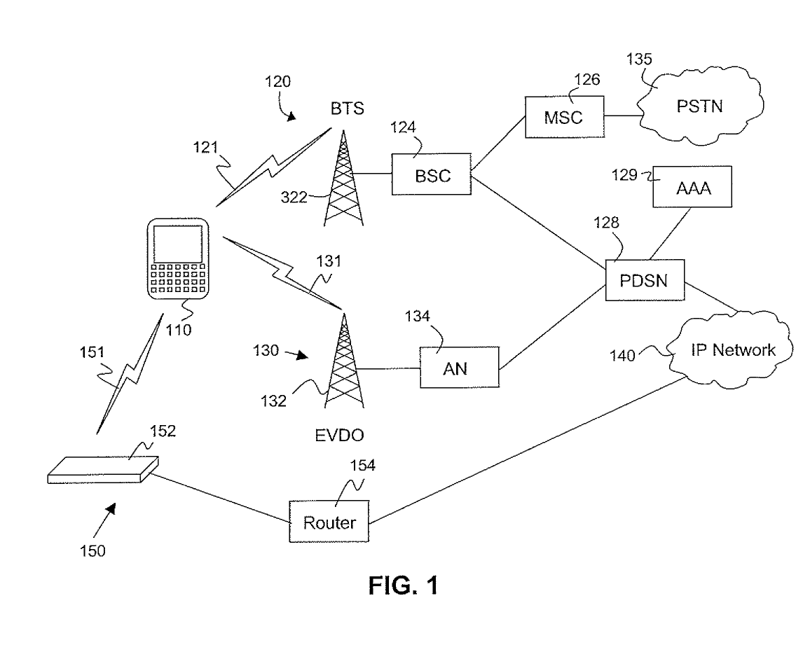

Reference is now made to FIG. 1. FIG. 1 is a block diagram of an exemplary wireless data network in accordance with the present disclosure and with which the various embodiments of the method of the instant disclosure may cooperate. FIG. 1 shows a block diagram of a wireless data device 110 and an exemplary CDMA 1x network 120, an exemplary EVDO network 130, a public switched telephone network (PSTN) 135, a data network 140 and a WiFi network 150 with which the instant techniques of the application may cooperate. Other network types such as GSM/GPRS/edge technology, among others are within the scope of the present disclosure, and the use of a CDMA/EVDO network is only an example used to provide context.

The wireless device 110 is preferably a multi-mode communication device having data and voice communication capabilities. As will be appreciated by those skilled in the art, the exemplary multi-mode device of FIG. 1 is also meant as an example of a multi-mode device and other multi-mode devices will exist. Further, the techniques of the present disclosure will also work with single mode devices and thus FIG. 1 is merely meant as an example and to provide context for the present application.

CDMA network 120 is comprised of a base transceiver station (BTS) 122 and a base station controller (BSC) 124. Base station controller 124 communicates with a mobile switching center 126 which, as will be appreciated, is a circuit switched only component communicating with PSTN 135. Base station controller 124 further communicates with a packet data serving node (PDSN) 128 which is a packet switched only component. PDSN 128 further communicates with IP network 140. IP network 140 is, in a preferred embodiment, the Internet.

EVDO network 130 contains and EVDO sector 132 which communicates with access node 134. Since the EVDO network 130 is a data only network, access node 134 communicates only with PDSN 128 and not with any circuit switched components.

WiFi network 150 includes an access point 152 communicating with mobile device 110. Access point 152 communicates with a router 154, which in turn communicates with the IP network 140.

The communication links between the mobile device and the CDMA 1x network is designated as connection 121. The connection between mobile device and the EVDO network is designated as connection 131. The connection between the mobile device and the WiFi network is designated as connection 151.

As will be appreciated by those skilled in the art, connections 121, 131 and 151 each have different characteristics. These characteristics can be defined in terms of the bandwidth, the latency, the cost, the reliability, and the security of the connection, among others. A multi-mode device with a wireless browser could, optimally, choose which connection to use to render various components on a web page.

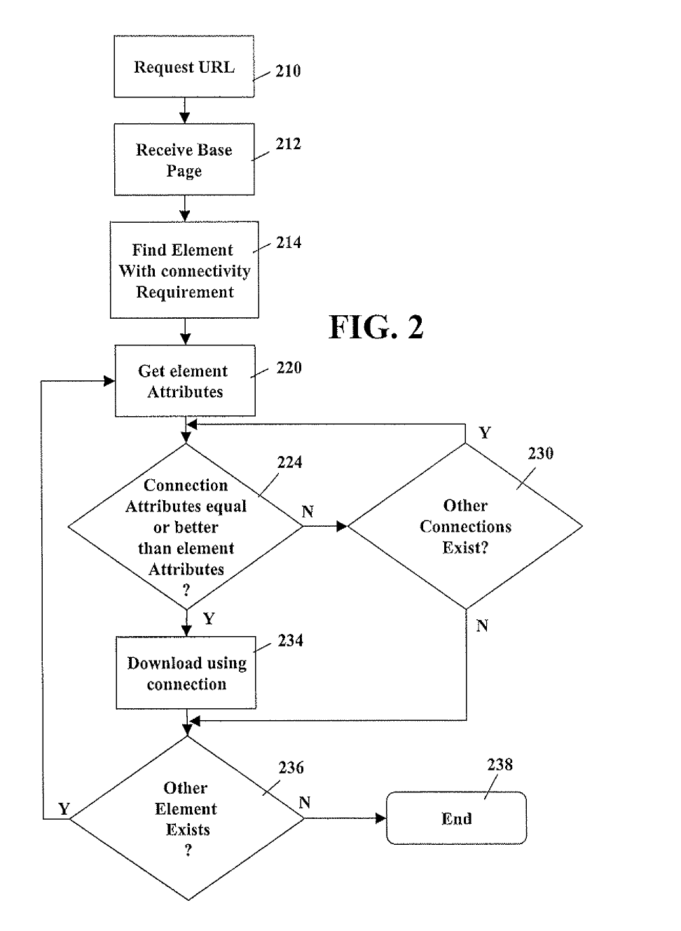

Reference is now made to FIG. 2. FIG. 2 discloses a method from a mobile device for providing the efficient dynamic and connectivity aware web browsing on a mobile device.

In step 210, a mobile browser requests a web page from the Internet. One such method of selecting a web page is through a uniform resource locator (URL).

In step 212, the mobile device receives the base HTML definition of the page that was requested by the URL. The base HTML definition, as will be appreciated by those skilled in the art, is the page that the browser requested and is received by the browser prior to the obtaining and rendering any links within the base HTML definition. For example, a web page may include text within the body of the page along with a link to an image. On a standard browser, the browser will first download the base HTML definition, which includes the text and the link. Subsequently it will go and obtain the image that is being pointed to by the link within the base HTML definition.

According to one embodiment of the present method, from step 212 the process proceeds to step 214 in which it scans the received main page to find whether there are any elements with connectivity requirements within the element.

As will be appreciated by those skilled in the art, step 214 can find whether the elements have connectivity requirements based on two different cycles of the life of the web page. These are the design time and the run time cycles. A design time cycle can include connectivity element attributes programmed within each element on a web page. When designing a web page, the web page developer can specify the connectivity requirements in the element. Thus, for example, using a tag labeled “CR” to designate a connectivity requirement, a designer could specify the following tag:
<img src=“./sample_img.jpg” CR_bandwidth=128 CR_latency=3 CR_cost=0.10 CR_security=2 CR_reliability=1>
   The above declaration of a connectivity requirement is however only meant as an example and other definitions of connectivity requirements may vary considerably from this example.

The above example of an image includes various connectivity requirements. As will be appreciated by those skilled in the art, not all of these connectivity requirements need to necessarily be within each element, but the above is provided for a more complete example.

The above code indicates that the bandwidth for downloading the image must be at least 128 Kbs/second. Thus, if the connection on the mobile device provides a bandwidth of less than 128 Kbs/second, the mobile device can choose not to receive that element of the web page.

The second element is CR_latency=3. This means that the latency must be less than or equal to 3 seconds. If the latency on the connection is greater than 3 seconds, the developer may choose to have the mobile device ignore that element or defer loading the element until a connection is established with a latency of less than three seconds. In other words, by placing a restriction in the link of “CR_latency=3”, the developer assures that the link will be ignored if the mobile device has no connection with a latency of greater than 3 seconds. While the developer may choose not to do this with images, latency could be more important for animation or streaming sound or video.

The element CR_cost=0.10 could indicate that the cost needs to be less than 10¢ per N bytes where N is an integer value. Thus, the developer could be indicating that the mobile device should only download the image if a favourable connection exists. For example, the network in multi-mode wireless device 110 of FIG. 1 has connections 121, 131 and 151. Mobile communications RF connections such as 121 and 131 may be a high cost connection and therefore the cost for downloading the image may be greater than 10¢ per N bytes. Conversely, a WiFi connection such as connection 151 may be a lower cost connection, and if the mobile device is connected to the WiFi network 150, it is worthwhile to download the image. Costs as used herein are not necessary specified in a dollar amount but instead can be a relative value such as “low”, “medium” or “high”.

The CR_security=2 parameter designates that the security of the connection needs to be at a certain level. For example, financial transactions may redirect the mobile device to a separate page. However, the mobile device may object to the redirection if the security of the link is not a certain level. The level of security could be based on a uniform definition of security levels, or further abstractions, such as encryption level, could be made within the connectivity requirements.

The CR_reliability=1 indicates the reliability. This is based on the type of network and in certain cases, receipt acknowledgements, data integrity, check sums, packet ordering, etc. are required. In such cases, the reliability needs to be at a certain level in order to load the element.

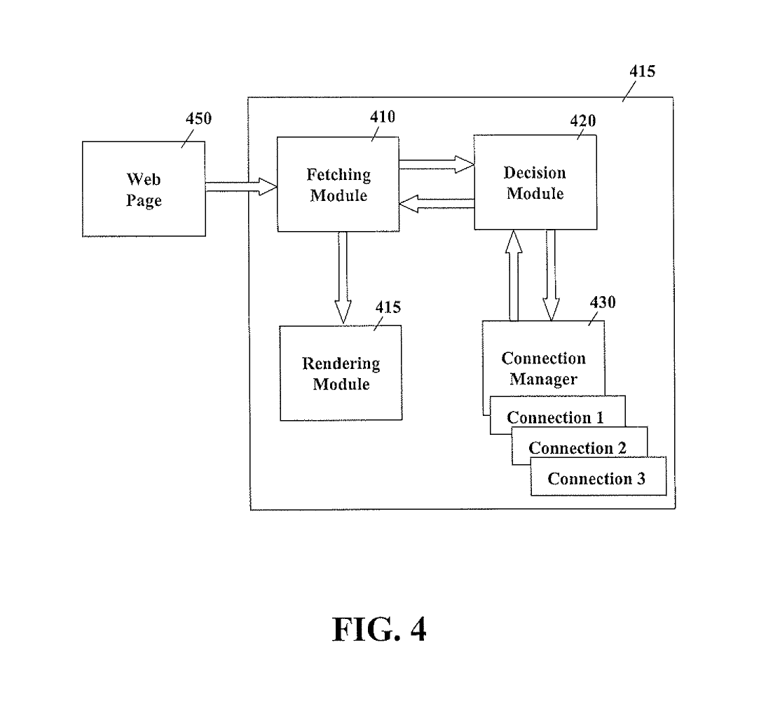

A second solution for step 214 is a run-time solution. In this case, the mobile browser would need additional components, as illustrated and described in FIG. 4 below. These elements include a decision module and a connection manager. Reference is now made to FIG. 4. FIG. 4 shows a browser 415 with a decision module 420 and a connection manager 430.

A fetching module 410 is responsible for interacting with a web page 450 and further a rendering module 415 is responsible for rendering the web page.

Decision module 420 is responsible for determining how a web page element will be processed. Based on available connections, the decision module can choose an appropriate connection for fetching the content for the web page element or ignore the element completely. The decision module uses the connection manager 430 to discover all connections currently available and corresponding connectivity attributes of each connection.

Connection manager 430 keeps track of all connections available at any given time. For every connection, connection manager 430 maintains a set of connectivity attributes characterizing the connection. These can include, but are not limited to, bandwidth, latency, cost, reliability and security. As will be appreciated by those skilled in the art, a subset of these attributes could also be maintained by the connection manager 430 and not all these attributes need to necessarily be maintained.

The attributes are stored in the same units for various connections on the connection manager 430 and also in the same units as those designated by the connectivity requirement (CR) tag used by web page developers.

When fetching and rendering a web page, the browser 415 extracts any content requirements found within the web page. These content requirements are passed on to the decision module 420, which instructs what actions should be taken for the elements. The decision module 420 makes the decision by matching an element's connectivity requirements to the connectivity attributes of any available connections.

As will be appreciated by those in the art, decision module 420 and connection manager 430 could also be located outside of browser 415. In this case, fetching module 410 and rendering module 415 are modified to communicate with the external decision module 420 and connection manager 430.

Referring again to FIG. 2 from step 214, the process proceeds to step 220. In step 220, the process gets the element attributes. As described above, these element attributes can be either explicitly within the tag that was provided by a designer or could be inherent based on the type of element. For example, in step 220 a web page that was not designed with connectivity requirements still has element types, such as images, sound, video, among others. Each of these element types is associated, by the mobile device, with certain connectivity requirements. Thus the mobile device might require a minimum bandwidth before allowing images to be downloaded or a maximum latency before streaming video is loaded. In a preferred embodiment each element type is associated with a predetermined connectivity profile that is stored on the mobile device. Other possibilities could include the dynamic changing of the connectivity profile for an element by a user. This may be used if the user wishes to receive a certain element type regardless of the connection

The process next proceeds to step 224 in which it checks whether the connection attributes matches or is better than required by the element attributes. As will be appreciated, certain comparisons require the connection attributes to be higher than the element attribute and other comparisons require the connection attributes to be lower than the element attribute. The bandwidth of a connection must be higher than or equal to the minimum bandwidth specified by the designer for an element or specified in the profile for the element. The cost of downloading on a connection must be lower than or equal to the maximum cost provided by for the element. The term “better” above is being used to refer to the connection attribute being higher than the element attribute (e.g. for bandwidth) or the connection attribute being lower than the element attribute (e.g. for latency), depending on the attribute.

For example, if, from FIG. 1, the CDMA 1X connection 121 is presently being used for browsing, the bandwidth provided by the connection might be lower than that required by the element attributes. In this case, as seen in FIG. 2, the process proceeds to step 230 in which the process checks whether any other connection is open or can be opened. If another connection is open or can be opened, for example connection 151 from FIG. 1, the process proceeds back to step 224 in which it checks whether or not the connection attributes of the new connection meets or exceeds the element attributes.

If yes, the process proceeds from step 224 to step 234 in which the element is downloaded using the connection found. The process next proceeds to step 236 in which it checks whether other elements are present within the received main page.

Similarly, if no other connection is available in step 230, the process ignores the element since it is not able to download it according to the element attributes and proceeds to step 236 in which it checks to see whether another element exists.

From step 236, if no other element exists, the process is ended in step 238. If a further element exists, the process proceeds back to step 220 in which it checks the element attributes of the next element and again sees whether or not the connection attributes are greater than or equal to the element attributes in order to download the element.

Thus each element is checked based on attributes designed by a page designer or stored in a profile for the element type. The element can be downloaded using a connection between the mobile device and the Internet if the connection attributes meet or are better than the element attributes. Otherwise the mobile device (or the browser within the mobile device) looks for other connections that may be used. In some cases the element will not be loaded at all based on one or more of the connection attributes on every connection being worse than the element attributes required. In this case the link would either be ignored or deferred until a suitable connection is available.

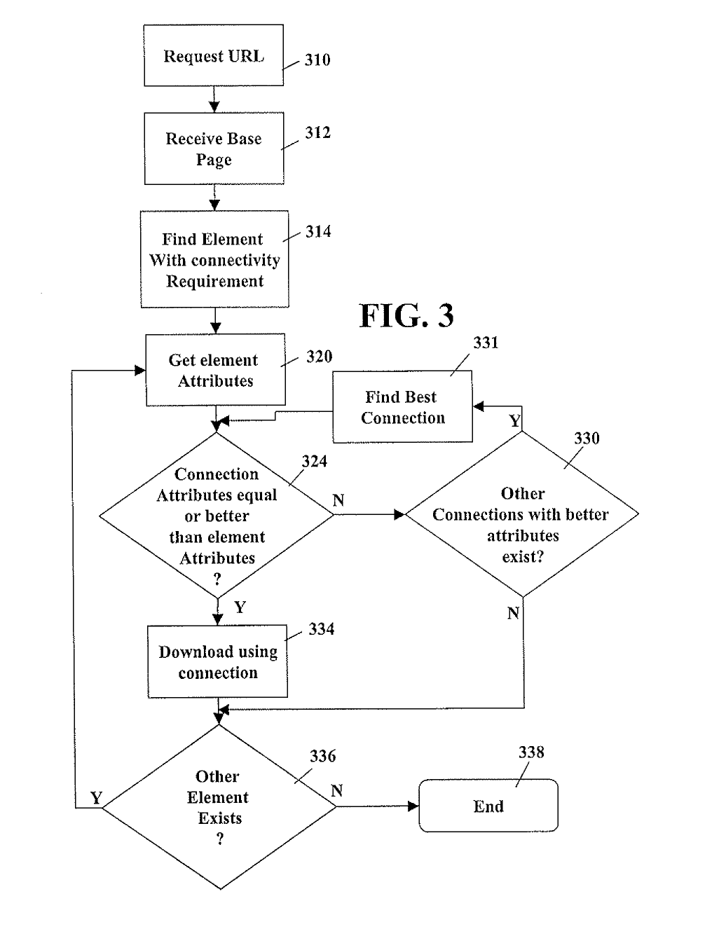

Reference is now made to FIG. 3. FIG. 3 discloses an alternative method to that of FIG. 2 for providing efficient dynamic and connectivity where web browsing on a mobile device.

In step 310, the mobile browser requests a web page from the Internet. This is similar to step 210 of FIG. 2.

In step 312, the mobile device receives the base HTML definition of the page that was requested by the URL, similar to step 212 of FIG. 2.

The process then proceeds to step 314 in which it scans the received main page to find whether there are any elements with connectivity requirements within the element.

The process proceeds to step 320 in which the process gets the element attributes. As described above, these element attributes can be either explicitly within the tag that was provided by a designer or could be inherent based on the type of element.

The process then proceeds to step 324 in which it checks to see whether the current connection has attributes that are better or equal than those required by the element attributes.

If not, the process proceeds to step 330 in which is checks whether other connections exist and if yes the process proceeds to step 331 in which the best connection that exists is found. As will be appreciated by those skilled in the art, the best connection that is available can be found in various ways. These can include finding all available connections and determining which best suits the element attributes that need to be downloaded. Various options including storing information on the mobile device until the connection is no longer visible to the mobile device also exist in order to expedite this process. Other options would be apparent to those skilled in the art.

From step 331, the process proceeds back to step 324 in which it checks to see whether the connection chosen has attributes equal to or better than the element attributes. If no, then the process proceeds back to step 330. However, in the case of FIG. 3, since the best connection was previously chosen in step 330, the check in step 330 will find that other connections with better attributes do not exist and thus the process proceeds to step 336 in which it checks whether other element types exist in the web page being requested.

Alternatively, from step 324 if the connection that is found has better or equal attributes to those of the element attributes then the element is downloaded using the connection in step 334.

From step 336, the process proceeds back to step 320 to get the remaining element attributes and the process continues in this way. From step 336 if there is no other element that exists, the process proceeds to step 338 and ends.

Thus, as opposed to FIG. 2 in which the first connection found that has equal or better attributes is used, the alternative method of FIG. 3 chooses the best connection within which to download the element attributes.

In a further alternative, steps 224 or 324 from FIG. 2 or 3 could perform a more intelligent check. Specifically, certain element attributes may be more important than others to a specific element type. Thus, for example, if an element has certain bandwidth, cost, and latency requirements, the important elements may be the bandwidth and the cost whereas the latency is a preferred element. In this case, the check in steps 324 and 224 could see whether or not the bandwidth or the cost is better than those required by the element attributes. Even if the latency requirement is not met, then the check in steps 224 and 324 could determine that a download can be made and thus proceed to step 234 or 334.

The above may also work with a predetermined ratio of the elements being present. Thus, for example, if two out of three element attributes are met then the decision in steps 224 and 324 may be to proceed with the download.

Further, a user may have the ability to specify certain element attributes as critical and others as non-critical. Thus, for example, a user could specify that cost is a critical element and therefore elements should not be downloaded if the cost exceeds the element cost. In this case, even if two out of three element attributes are present, if the element attribute that is not present is cost, a download will not occur.

Other decision criteria are possible for steps 224 and 324 of FIGS. 2 and 3.

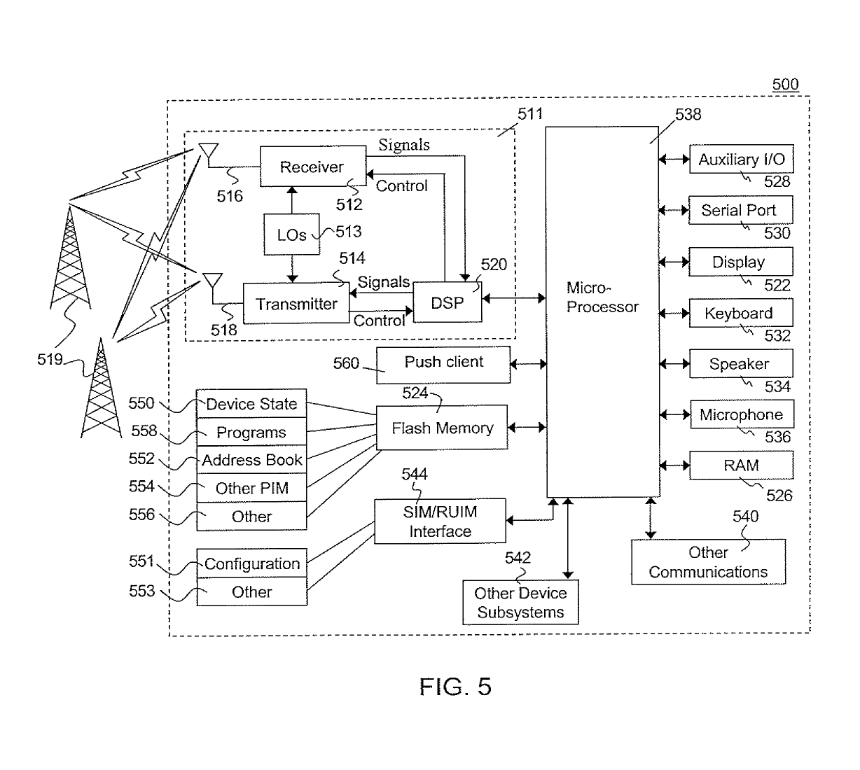

As will be appreciated, the above can be implemented on any mobile device or other device with one or more Internet Protocol network access means. One exemplary mobile device is described below with reference to FIG. 5. This is not meant to be limiting, but is provided for illustrative purposes.

FIG. 5 is a block diagram illustrating a mobile device apt to be used with preferred embodiments of the apparatus and method of the present application. Mobile device 500 is preferably a two-way wireless communication device having at least voice and data communication capabilities. Mobile device 500 preferably has the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 500 is enabled for two-way communication, it will incorporate a communication subsystem 511, including both a receiver 512 and a transmitter 514, as well as associated components such as one or more, preferably embedded or internal, antenna elements 516 and 518, local oscillators (LOs) 513, and a processing module such as a digital signal processor (DSP) 520. As will be apparent to those skilled in the field of communications, the particular design of the communication subsystem 511 will be dependent upon the communication network in which the device is intended to operate.

Network access requirements will also vary depending upon the type of network 519. In some CDMA networks network access is associated with a subscriber or user of mobile device 500. A CDMA mobile device may require a removable user identity module (RUIM) or a subscriber identity module (SIM) card in order to operate on a CDMA network. The SIM/RUIM interface 544 is normally similar to a card-slot into which a SIM/RUIM card can be inserted and ejected like a diskette or PCMCIA card. The SIM/RUIM card can have approximately 64K of memory and hold many key configuration 551, and other information 563 such as identification, and subscriber related information.

When required network registration or activation procedures have been completed, mobile device 500 may send and receive communication signals over the network 519. As illustrated in FIG. 5, network 519 can consist of multiple base stations communicating with the mobile device. For example, in a hybrid CDMA 1x EVDO system, a CDMA base station and an EVDO base station communicate with the mobile device and the mobile device is connected to both simultaneously. The EVDO and CDMA 1x base stations use different paging slots to communicate with the mobile device.

Signals received by antenna 516 through communication network 519 are input to receiver 512, which may perform such common receiver functions as signal amplification, frequency down conversion, filtering, channel selection and the like, and in the example system shown in FIG. 5, analog to digital (A/D) conversion. A/D conversion of a received signal allows more complex communication functions such as demodulation and decoding to be performed in the DSP 520. In a similar manner, signals to be transmitted are processed, including modulation and encoding for example, by DSP 520 and input to transmitter 514 for digital to analog conversion, frequency up conversion, filtering, amplification and transmission over the communication network 519 via antenna 518. DSP 520 not only processes communication signals, but also provides for receiver and transmitter control. For example, the gains applied to communication signals in receiver 512 and transmitter 514 may be adaptively controlled through automatic gain control algorithms implemented in DSP 520.

Mobile device 500 preferably includes a microprocessor 538 which controls the overall operation of the device. Communication functions, including at least data and voice communications, are performed through communication subsystem 511. Microprocessor 538 also interacts with further device subsystems such as the display 522, flash memory 524, random access memory (RAM) 526, auxiliary input/output (I/O) subsystems 528, serial port 530, one or more keyboards or keypads 532, speaker 534, microphone 536, other communication subsystem 540 such as a short-range communications subsystem and any other device subsystems generally designated as 542. Serial port 530 could include a USB port or other port known to those in the art.

Some of the subsystems shown in FIG. 5 perform communication-related functions, whereas other subsystems may provide “resident” or on-device functions. Notably, some subsystems, such as keyboard 632 and display 522, for example, may be used for both communication-related functions, such as entering a text message for transmission over a communication network, and device-resident functions such as a calculator or task list.

Operating system software used by the microprocessor 538 is preferably stored in a persistent store such as flash memory 524, which may instead be a read-only memory (ROM) or similar storage element (not shown). Those skilled in the art will appreciate that the operating system, specific device applications, or parts thereof, may be temporarily loaded into a volatile memory such as RAM 526. Received communication signals may also be stored in RAM 526.

As shown, flash memory 524 can be segregated into different areas for both computer programs 558 and program data storage 550, 552, 554 and 556. These different storage types indicate that each program can allocate a portion of flash memory 524 for their own data storage requirements. Microprocessor 538, in addition to its operating system functions, preferably enables execution of software applications on the mobile device. A predetermined set of applications that control basic operations, including at least data and voice communication applications for example, will normally be installed on mobile device 500 during manufacturing. Other applications could be installed subsequently or dynamically.

A preferred software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 519. In a preferred embodiment, the PIM data items are seamlessly integrated, synchronized and updated, via the wireless network 519, with the mobile device user's corresponding data items stored or associated with a host computer system. Further applications may also be loaded onto the mobile device 500 through the network 519, an auxiliary I/O subsystem 528, serial port 530, short-range communications subsystem 540 or any other suitable subsystem 542, and installed by a user in the RAM 526 or preferably a non-volatile store (not shown) for execution by the microprocessor 538. Such flexibility in application installation increases the functionality of the device and may provide enhanced on-device functions, communication-related functions, or both. For example, secure communication applications may enable electronic commerce functions and other such financial transactions to be performed using the mobile device 500.

In a data communication mode, a received signal such as a text message or web page download will be processed by the communication subsystem 511 and input to the microprocessor 538, which preferably further processes the received signal for element attributes for output to the display 522, or alternatively to an auxiliary I/O device 528. A push client 560 could also process the input.

A user of mobile device 500 may also compose data items such as email messages for example, using the keyboard 532, which is preferably a complete alphanumeric keyboard or telephone-type keypad, in conjunction with the display 522 and possibly an auxiliary I/O device 528. Such composed items may then be transmitted over a communication network through the communication subsystem 611.

For voice communications, overall operation of mobile device 500 is similar, except that received signals would preferably be output to a speaker 534 and signals for transmission would be generated by a microphone 536. Alternative voice or audio I/O subsystems, such as a voice message recording subsystem, may also be implemented on mobile device 500. Although voice or audio signal output is preferably accomplished primarily through the speaker 534, display 522 may also be used to provide an indication of the identity of a calling party, the duration of a voice call, or other voice call related information for example.

Serial port 530 in FIG. 5 would normally be implemented in a personal digital assistant (PDA)-type mobile device for which synchronization with a user's desktop computer (not shown) may be desirable, but is an optional device component. Such a port 530 would enable a user to set preferences through an external device or software application and would extend the capabilities of mobile device 500 by providing for information or software downloads to mobile device 500 other than through a wireless communication network. The alternate download path may for example be used to load an encryption key onto the device through a direct and thus reliable and trusted connection to thereby enable secure device communication. As will be appreciated by those skilled in the art, serial port 530 can further be used to connect the mobile device to a computer to act as a modem.

Other communications subsystems 540, such as a short-range communications subsystem, is a further optional component which may provide for communication between mobile device 500 and different systems or devices, which need not necessarily be similar devices. For example, the subsystem 540 may include an infrared device and associated circuits and components or a Bluetooth™ communication module to provide for communication with similarly enabled systems and devices. Subsystem 540 may also be used for WiFi communications.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

We claim:

1. A method for dynamic and connectivity aware web page rendering on a device having at least one connection to an Internet protocol network, the method comprising the steps of:
requesting a web page;
receiving the web page requested along with links to at least one element within the web page;
finding connectivity requirements for an element selected from the at least one element;
checking whether attributes of any one of the at least one connection are better than the connectivity requirements for the element; and
if yes, downloading the element using the any one of the at least one connection whose attributes are better than the connectivity requirements for the element.

2. The method of claim 1, wherein the connectivity requirements of the element and the attributes of any one of the at least one connection are one or more attributes selected from the group consisting of minimum bandwidth, maximum latency, maximum cost per traffic, minimum reliability and minimum security.

3. The method of claim 1, wherein the finding step comprises searching the web page for connectivity requirement tags embedded therein.

4. The method of claim 1, wherein the finding step comprises assigning the element connectivity requirements based on an element type.

5. The method of claim 4, wherein the assigning step utilizes data stored on the device by a service provider for the device.

6. The method of claim 4, wherein the assigning step utilizes data defined by a user of the device.

7. The method of claim 1, wherein the downloading step utilizes the any one of the at least one connection whose attributes best meet the connectivity requirements of the element.

8. The method of claim 1, wherein, if the checking step find the attributes of any one of the at least one connection are not better than the connectivity requirements for the element, the downloading of the element is deferred until a new connection whose attributes are better than the connectivity requirements of the element is established.

9. The method of claim 1, wherein the at least one connection is not yet opened between the device and the Internet Protocol network.

10. The method of claim 1, wherein the checking step further finds the at least one connection with the best attributes for the connectivity requirements of the element.

11. The method of claim 1, wherein the checking step is positive if a predetermined ratio of connectivity requirements is present in the connection attributes.

12. A device for dynamic and connectivity aware web page rendering, the device having a communications subsystem adapted to communicate utilizing at least one connection to an Internet protocol network; memory; a user interface; a processor adapted to run user applications and interact with the memory, the communications subsystem and the user interface and adapted to run applications, the device characterized by having:
a fetching module utilizing the communications subsystem to request a web page and receive the web page requested along with links to at least one element within the web page;
a connection module adapted to track attributes of the at least one connection;
a decision module communicating with the fetching module and the communication module, the decision module adapted to find connectivity requirements for an element selected from the at least one element and check whether attributes of any one of the at least one connection are better than the connectivity requirements for the element; and
if yes, the decision module being adapted to instruction the fetching module to download the element using the any one of the at least one connection whose attributes are better than the connectivity requirements for the element.

13. The device of claim 12, wherein the connectivity requirements of the element and the attributes of any one of the at least one connection are one or more attributes selected from the group consisting of minimum bandwidth, maximum latency, maximum cost per traffic, minimum reliability and minimum security.

14. The device of claim 12, wherein the decision module is adapted to find connectivity requirements by searching the web page for connectivity requirement tags embedded therein.

15. The device of claim 12, wherein the decision module is adapted to find connectivity requirements by assigning the element connectivity requirements based on an element type.

16. The device of claim 15, wherein the decision module is adapted to assign by utilizing data stored in the memory on the device by a service provider for the device.

17. The device of claim 15, wherein the decision module is adapted to assign by utilizing data defined by a user of the device.

18. The device of claim 12, wherein the decision module is adapted to instruct the fetching module to utilize the any one of the at least one connection whose attributes best meet the connectivity requirements of the element.

19. The device of claim 12, further comprising a rendering module adapted to render web pages and any element downloaded by the fetching module on the user interface of the device.

20. The device of claim 12, wherein the at least one connection is not yet opened between the device and the Internet Protocol network.

21. The device of claim 12, wherein the decision module is adapted to instruct the fetching module to download the element using the at least one connection with the best attributes for the connectivity requirements of the element.

22. The device of claim 12, wherein the decision module is adapted to instructs the fetching module to download the element if a predetermined ratio of connectivity requirements is present in the connection attributes.
